(19) United States
(12) Patent Application Publication
(10) Pub. No.: US 2015/0287274 A1
(43) Pub. Date: Oct. 8, 2015

(54) CUSTOMIZATION PROCESS FOR SEATING APPARATUS FOR OPERATION OF A GAME OF CHANCE

(71) Applicant: Casino Game Maker, Inc., Las Vegas, NV (US)

(72) Inventor: Andrzej Surmacz, Las Vegas, NV (US)

(73) Assignee: CASINO GAME MAKER, INC., Las Vegas, NV (US)

(21) Appl. No.: 14/541,118

(22) Filed: Nov. 13, 2014

Related U.S. Application Data
(63) Continuation-in-part of application No. 14/244,879, filed on Apr. 3, 2014.

(51) Int. Cl. G07F 17/32

(52) U.S. Cl. CPC G07F 17/3216

(57) ABSTRACT

An integrated platform apparatus is provided. The integrated platform apparatus comprises a chasse and a customization component that is operably connected to the chasse that customizes the integrated platform for operation of a game of chance. A process provides a display of a plurality of customization components that customizes an integrated platform for operation of a game of chance. Further, the process receives a selection of a customization component from the plurality of customization components.

### RELATED APPLICATIONS

This patent application is a Continuation-In-Part patent application of U.S. patent application Ser. No. 14/244,879, filed on Apr. 3, 2014, entitled SEATING APPARATUS FOR OPERATION OF A GAME OF CHANCE.

### BACKGROUND

1. Field

This disclosure generally relates to the field of gaming. More particularly, the disclosure relates to customization of gaming devices utilized to operate games of chance.

2. General Background

Casino game slot machines are typically provided throughout a casino gaming floor. Each casino game slot machine is typically dedicated to providing game play for a particular game of chance. Accordingly, a player that wants to play that particular game of chance has to search the casino gaming floor for that particular game of chance. As a typical casino gaming floor may have many slot machines, the player has to search through those slot machines for the particular game of chance.

Further, many players typically have a variety of different games of chance that they want to play at the casino. Accordingly, the players have to search for each game throughout the casino gaming floor. Such search may require travelling to distant portions of the casino gaming floor. Therefore, the player may have to go through a tiring and cumbersome process of meandering through a casino to find and play different casino games of chance.

Many players may not play the games they want to play because the process of finding casino games is so cumbersome. Accordingly, casinos do not obtain game revenue from customers that do not play certain games of chance. The current approach does not allow customers to easily find and play a variety of games of chance.

Another problem with current casino game configurations is the lack of variety of types of game machines provided by different casinos. Casinos have typically leased or purchased their slot machines from only a few manufacturers. As a result, customers visiting different casinos find the same casino slot machines and games present in different casinos. The only difference between casinos is the Return To Player (“RTP”), which is typically higher in the locals markets rather than the visitor markets. The casino industry has experienced significant stagnation by not being to generate interest amongst the millennial generation.

Casinos have added non-gaming venues to attempt to generate interest amongst the millenials, but that has simply not helped increase the conversion rate of casino goers to slot players. Further, casinos have tried to utilize social media to interact with customers to attempt to generate interest by millenials for slot games. Such attempts have generated some interest amongst millenials in slot games provided in an online casino brand specific interactive experience, but have not resulted in significant changes in customer interest for casino floor slot games. Customers have found that the brand specific online interactive experiences are only present online and do not extend well to the physical casino slot experiences on casino floors. Customers have found that the physical slot games present on casino floors are not much different than previous configurations. Brand specific slot games are not present on casino game floors because the casino industry lacks slot machine customization. Slot machine manufacturers typically require orders of five hundred to one thousand units before they will even consider a minor customization. As a result, casino operators are limited in trying to customize a slot machine with any type of significant customization such as a brand specific customization.

Current casino configurations have not generated enough interest from millenials to reduce the declining interest in physical slot games. Millenials are simply not finding the current slot game configurations exciting as the slot machines and the method of playing those slot machines has not substantially changed since the inception of slot machines. Therefore, current casino configurations are not adequately generating revenue for casinos for physical slot games on casino floors.

### SUMMARY

In one aspect of the disclosure, an integrated platform apparatus is provided. The integrated platform apparatus comprises a chasse and a customization component that is operably connected to the chasse that customizes the integrated platform for operation of a game of chance.

In another aspect of the disclosure, a process is provided. The process provides a display of a plurality of customization components that customizes an integrated platform for operation of a game of chance. Further, the process receives a selection of a customization component from the plurality of customization components.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1A illustrates a front view of a seating apparatus for operation of a game of chance.

FIG. 1B illustrates a back view of the seating apparatus illustrated in FIG. 1A.

FIG. 1C illustrates a side view of the seating apparatus illustrated in FIG. 1A.

FIG. 1D illustrates a top view of the seating apparatus illustrated in FIG. 1A.

FIG. 2 illustrates the components of the insert module illustrated in FIGS. 1C and 1D.

FIG. 3 illustrates a side view of a seating apparatus configuration in which the seating apparatus illustrated in FIG. 1 is situated in proximity to a display screen.

FIG. 4 illustrates a top view of a seating apparatus configuration.

FIG. 5 illustrates a multiple player gaming apparatus configuration.

FIG. 6 illustrates a system that may be positioned within the cabinet of the seating apparatus illustrated in FIG. 1B.

FIG. 7 illustrates an integrated platform that integrates customizations for the seating apparatus for operation of the game of chance.

FIG. 8 illustrates a customization component online ordering system.

FIG. 9 illustrates an example of a customization order display.

FIG. 10 illustrates a process that is utilized provide ordering of integrated platform.

### DETAILED DESCRIPTION

A seating apparatus for operation of a game of chance is provided. An example of a seating apparatus is a gaming chair that has functionality built into the gaming chair for operation of a game of chance. Further, the seating apparatus allows a player to select from a variety of games of chance from the same seating apparatus. In contrast with a player playing a particular game of chance at a slot machine that is dedicated to operation of a particular game of chance and that player having to meander through the casino to find other slot machines dedicated to different games of chance, the player may have a dedicated seating apparatus to the player. The player may then utilize the seating apparatus to select a particular game of chance from a variety of games of chance and then play that game of chance. Upon completion of that game of chance, the player may continue to play the same game of chance or select a different game of chance from the same seating apparatus. The seating apparatus provides a lean back approach to gaming rather than a lean forward approach. A player can relax during game play in a reclined position.

The seating apparatus for operation of a game of chance allows a player to enjoy a variety of game play experiences with different games of chance without having to meander throughout the casino gaming floor. Upon finding a seating apparatus within a casino gaming floor, the player is able to comfortably select and play a variety of different games of chance from the same seating apparatus.

Accordingly, the seating apparatus allows a casino to develop increased revenue from players wasting less time searching for various different games of chance. During the time period that a player may walk from dedicated slot machine to dedicated slot machine, the player at the seating apparatus may be playing different games of chance that provide revenue for a casino. The player may enjoy a more comfortable game play experience whereas the casino may develop increased revenue from the seating apparatus.

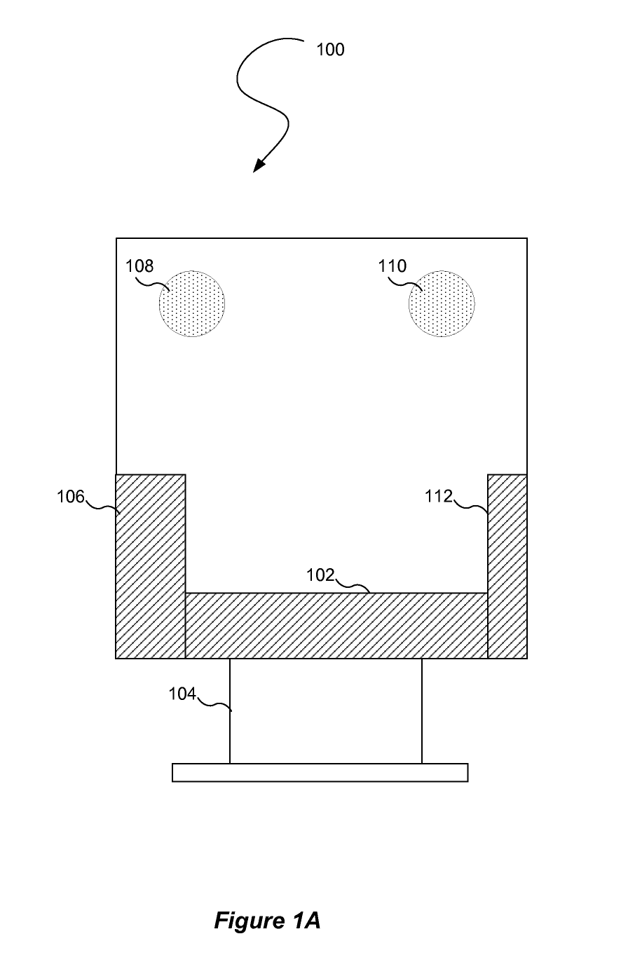

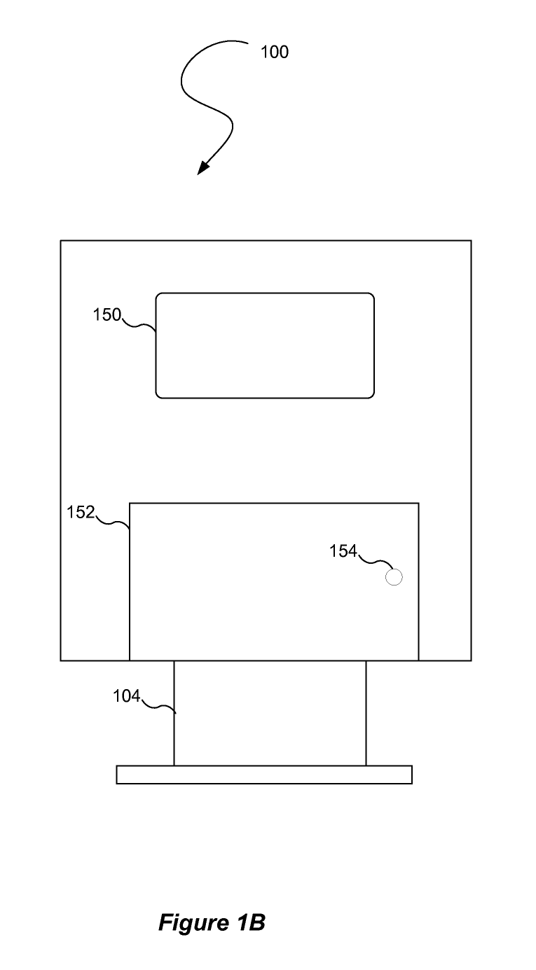

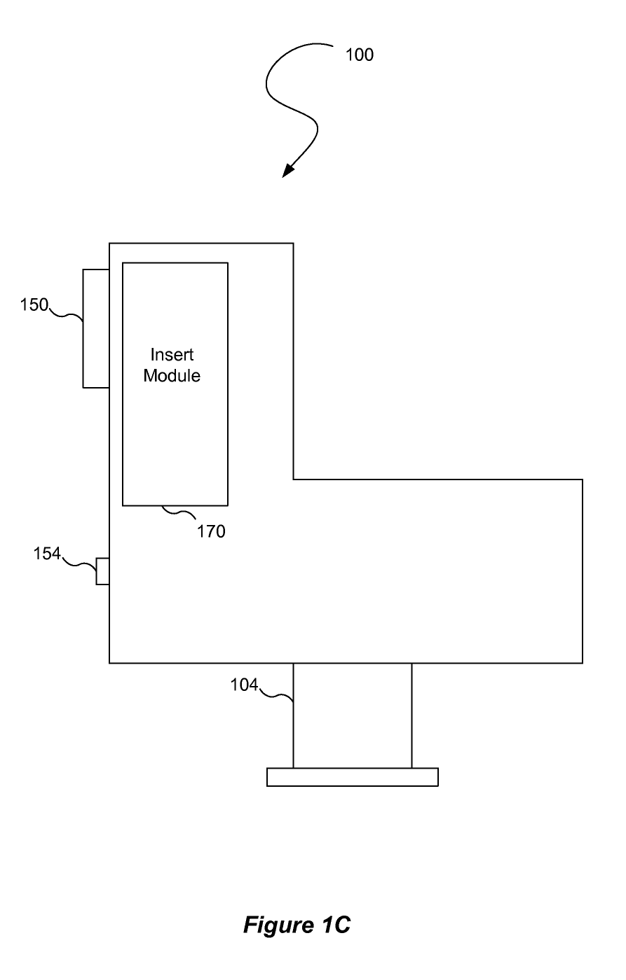

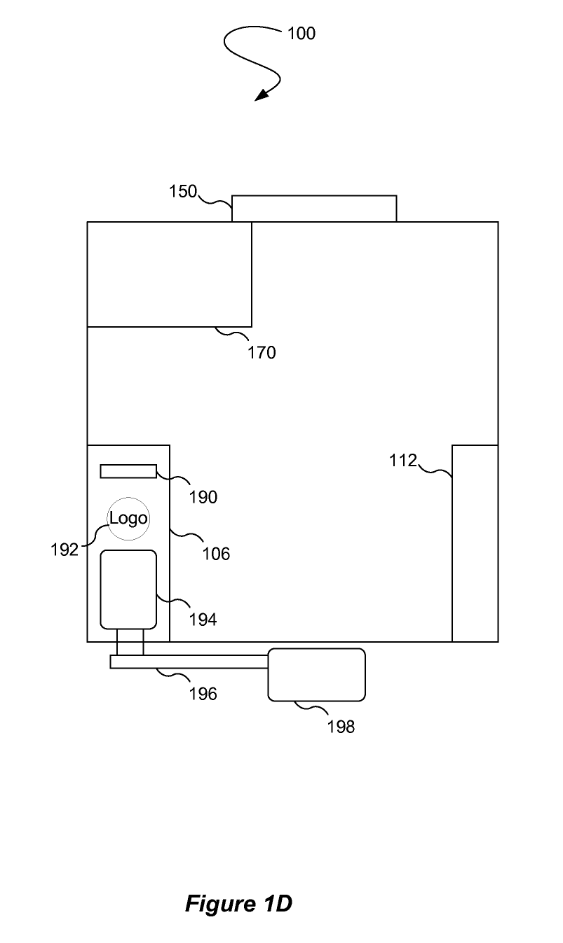

FIG. 1A illustrates a front view of a seating apparatus 100 for operation of a game of chance. The seating apparatus 100 may be utilized by a player to select a game of chance and operate that game of chance. In other words, the seating apparatus 100 has built in and integrated functionality within itself to allow the player to select a game of chance from a plurality of games of chance and operate the selected game of chance.

The seating apparatus 100 includes a seating receptacle 102 on which a player is situated. The seating receptacle 102 is operably connected to a stand 104. The stand 104 may be operably attached to the seating receptacle 102 via connecting means such as adhesives, fasteners, etc. Alternatively, the stand 104 may be integrated with the seating receptacle 102 as a portion of the seating receptacle 102. The stand 104 may be selected from a variety of types of mechanisms for maintaining elevation of the seating receptacle 102. For example, a plurality of legs may be utilized as the stand 104.

Further, the seating apparatus 100 may include an armrest 106. In one aspect of the disclosure, the armrest 106 may include a plurality of controls that allow the user to select a game of chance from a plurality of games of chance and/or operate game play for the selected game of chance. In another aspect, the user controls may be situated in another part of the seating apparatus 100 or may be operably connected to the seating apparatus 100.

In addition, the seating apparatus 100 may also include an additional armrest 112. The additional armrest 112 may or may not have any integrated control functionality.

In an aspect of the disclosure, the seating apparatus 100 may include a plurality of audio speakers 108 and 110 to provide sound effects associated with a particular game of chance during operation of the game of chance. The seating apparatus 100 controls the sound effects emanating from the plurality of audio speakers 108 and 110. For example, a processor situated in the seating apparatus 100 may determine which sound effects are to be played during operation of the game of chance. Further, the user may utilize controls integrated into the armrest 106 to adjust the sound of the audio effects emanating from the plurality of speakers 108 and 110.

Although the plurality of audio speakers is illustrated in FIG. 1, a single audio speaker or more than two audio spears may be utilized. Alternatively, the seating apparatus 100 may be utilized without any audio speakers. In another aspect of the disclosure, a vibration mechanism may be utilized for vibration effects based upon audio and/or events corresponding to the game of chance being played.

FIG. 1B illustrates a back view of the seating apparatus 100 illustrated in FIG. 1A. A display screen 150 may be positioned on the back of the seating apparatus 100. The display screen 150 may be utilized to provide a variety of functions. For example, the display screen 150 may be utilized to provide advertisements for particular games of chance, casino promotions, etc. The display screen 150 may display such data when a player is or not situated at the seating apparatus 100. Accordingly, other players may view the displayed data on the back of the seating apparatus 100 whether or not a player is playing a game of chance at the seating apparatus 100. The display screen 150 may also be utilized to provide information to casino employees that are fixing, maintaining, updating, etc. the seating apparatus 100.

The seating apparatus 100 also has a cabinet 152. The cabinet 152 may be locked by a lock 154 or other locking mechanism. The cabinet 152 may store the operational components of the seating apparatus 100 that allow a player to select a game of chance from a plurality of games of chance. For instance, the cabinet 152 may store a processor that selects and operates games of chance, a data storage device that stores games of chance, etc. For example, the processor or processors may be situated on a board or on a plurality of boards stored in the cabinet 152. As an example, the plurality of boards may be communication boards that communicate with a back end system, e.g., a board that communicates with a player tracking system, a board that communicates with a slot accounting system, a board that communicates with an accounting wagering system, a board that communicates with a ticket in and ticket out system, and/or any other communication board that may be utilized to interface with a network on a casino gaming floor. The processor or processors may be utilized to also provide for payment and player game tracking. For example, the processor or processors may operate payment mechanisms integrated into the seating apparatus 100 to accept payment for game play and may award or redeem player points for game play. The processor or processors may also be utilized to perform facial recognition functionality to recognize the player. For instance, a camera that is operably attached to the seating apparatus 100 may perform an image capture of the player prior to or during game play at the seating apparatus 100. The processor or processors may then compare the image with a plurality of images stored in a local database stored in a storage device located within the seating apparatus 100 or in a remote database to which the processor or processors are in operable communication. After identifying the player from the database, the processor or processors may then customize game play for that particular player, provide particular promotions for that particular player, tabulate game points for that particular player, favorite games, return on play, etc. As an example, the seating apparatus 100 may recognize a player and automatically display a menu of the player's favorite games. The player may also have previously provided an input for a particular look and feel for different games. Those configurations may automatically be displayed to the player after the seating apparatus 100 recognizes the player.

FIG. 1C illustrates a side view of the seating apparatus 100 illustrated in FIG. 1A. The seating apparatus 100 includes an insert module 170 that may be inserted into the seating apparatus 100. The insert module 170 provides various payment functionality. The insert module 170 may be inserted into the seating apparatus 100 through the top of the seating apparatus 100, the side of the seating apparatus 100, the back of the seating apparatus 100, the bottom of the seating apparatus 100, or through the cabinet 152.

FIG. 1D illustrates a top view of the seating apparatus 100 illustrated in FIG. 1A. In an aspect of the disclosure, the armrest 106 includes a card reader 190. For example, a player may have a casino player's card that the user may be able to utilize for payment of a game of chance. The player's card may also have points that may be redeemed by the player for game play of the game of chance. Further, points may be awarded to the player based upon an outcome of the game of chance.

In another aspect of the disclosure, the armrest 106 may have a logo 192. For example, the logo may be a casino logo. Alternatively, the logo 192 may be an advertiser's logo or an advertisement from an advertiser.

In yet another aspect of the disclosure, the armrest 106 may have a user control panel 194. The user control panel 194 may be a panel of buttons, a touch screen display screen, etc. A player may utilize the user control panel 194 to select a game of chance, operate a game of chance, request food and drink, etc.

In another aspect, a connecting mechanism 196 is operably connected to the armrest 106 and a display screen 198. The connecting mechanism 196 may be a swivel arm that is adjustable by the player. Alternatively, the connecting mechanism 196 may be fixed. The display screen 198 may be a tablet device, a touch screen display, an LCD display screen, etc. In an aspect of the disclosure, the player may operate the game of chance with the user control panel 190 and view the game of chance on the display screen 198. Alternatively, the player may operate the game of chance with the display screen 198 via touch screen inputs. The player may then view the game of chance on the display screen 198 or on a display screen situated in proximity to the seating apparatus 100. In one implementation, a locking device may be utilized to prevent the display screen 198 from being removed from the seating apparatus 100. For example, the locking mechanism may be utilized to prevent a tablet device from being removed.

In yet another aspect of the disclosure, additional or alternative input devices may be utilized for game selection and/or game operation. For example, a joystick may be operably connected, e.g., wired or wirelessly, to the seating apparatus 100 or integrated within the seating apparatus 100 for operation of the game of chance.

In another aspect of the disclosure, a gesture recognition system may be utilized to recognize inputs from the user. For example, a motion capture system utilizing an image capture device and an image recognition processor may be utilized to associate gestures provided by a motion of a hand or digit of the user in the air. The image recognition processor then associates particular gestures with particular commands. Such gesture recognition system may be utilized in conjunction with the user control panel 194 to provide the player with alternative input mechanisms or without the user control panel 194.

In yet another aspect of the disclosure, a voice recognition system may be utilized to recognize voice inputs form the user. For example, a voice recognition system utilizing a microphone and an audio recognition processor may be utilized to recognize audio commands in conjunction with or without the user control panel 194.

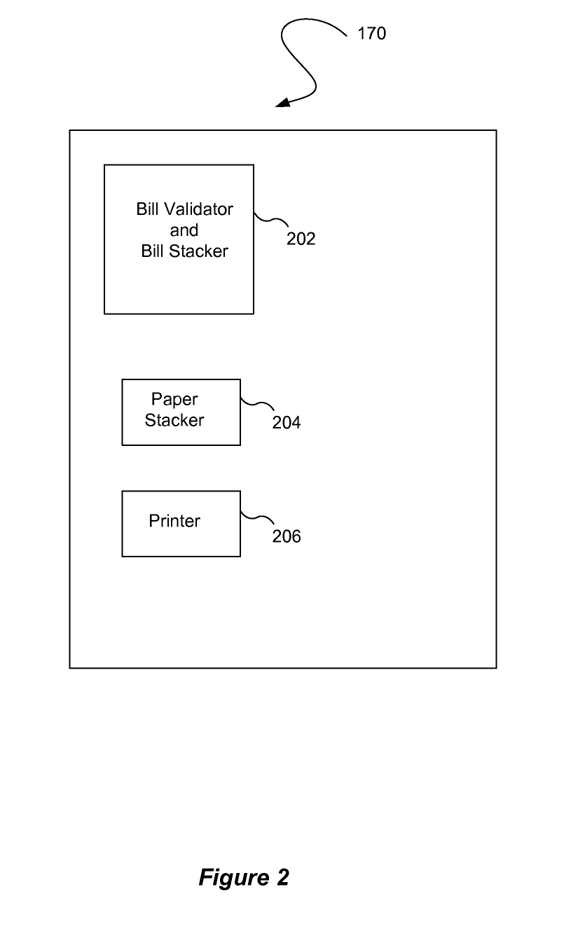

FIG. 2 illustrates the components of the insert module 170 illustrated in FIGS. 1C and 1D. The insert module 170 may include a bill validator and bill stacker 202, a paper stacker 204, and a printer 206. The card reader 190 illustrated in FIG. 1D allows the user to provide electronic payment via a card reader 190 that debits a player's account electronically. The insert module 170 allows a player to provide payment via cash, coins, or method other than a player's card. The insert module 170 then prints a receipt for the player. Accordingly, the seating apparatus 100 allows a player to provide payment for a game of chance through a variety of payment methods.

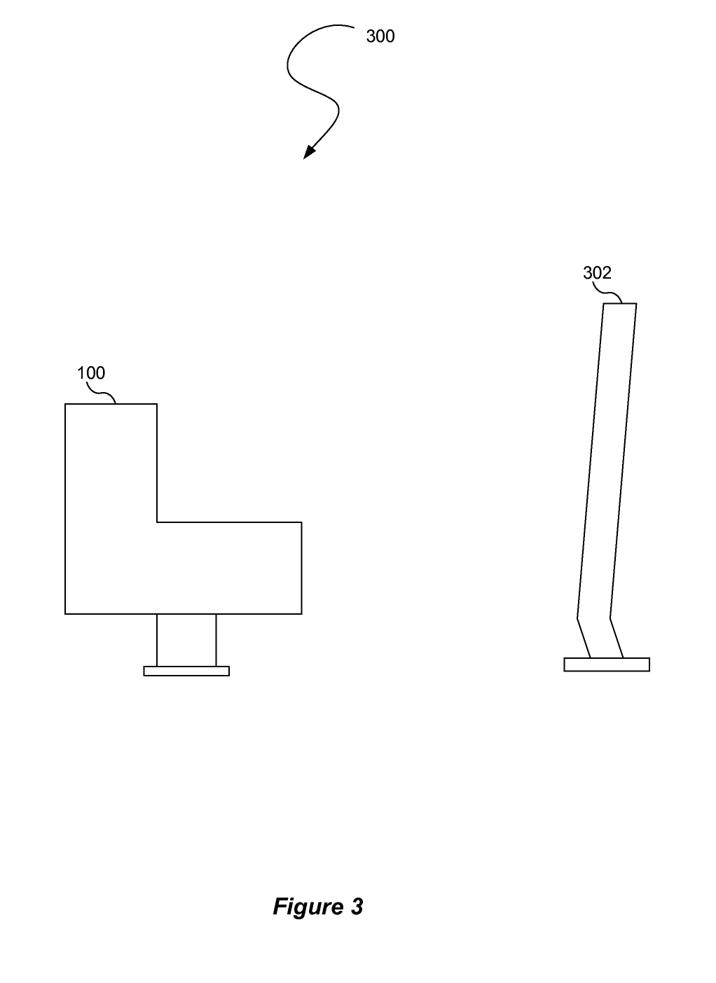

FIG. 3 illustrates a side view of a seating apparatus configuration 300 in which the seating apparatus 100 illustrated in FIG. 1 is situated in proximity to a display screen 302. The player selects and operates a game of chance from the seating apparatus 100, but views the game of chance at a display screen 302 that is distinct from the seating apparatus 100. The display screen 302 is in operable communication with the seating apparatus 100, e.g., wired or wireless communication. In an aspect of the disclosure, the display screen 302 may be a touch screen. The display screen 302 may be utilized to display data corresponding to the game of chance for the player situated at the seating apparatus 100. The display screen 302 may also be utilized to display advertisements. The advertisements may be adjusted to correspond to a particular game of chance. Accordingly, the advertisement may appear as a portion of the game of chance. The display screen 302 may also be utilized to display advertisements that do not correspond to the game of chance. The seating apparatus 100 may also be utilized to display advertisements that correspond to the game of chance or other types of advertisements that do not correspond to the game of chance. For example, the display screen 150 or the display screen 198 may be utilized to display advertisements. In one implementation, the display screen 302 is enclosed within a cabinet. Other components, e.g., audio components for the display screen 302, may also be enclosed within the cabinet. A locking device may be utilized to prevent access to the cabinet. In one implementation, the high voltage components that are utilized to operate the seating apparatus 100 are stored in the cabinet in proximity to the display screen 302. As a result, the player is not sitting in proximity to high voltage electronic components. Therefore, the cabinet provides for a safer seating apparatus 100 than having the high voltage electronic components in proximity to the player.

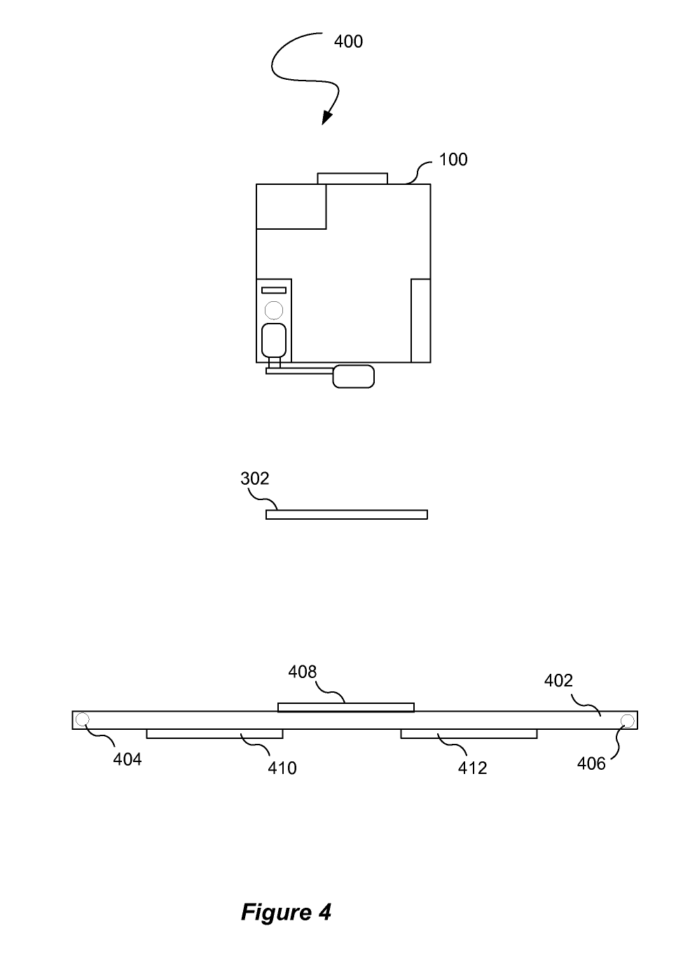

FIG. 4 illustrates a top view of a seating apparatus configuration 400. The seating apparatus 100 is situated in proximity to the display screen 302 illustrated in FIG. 3 and a wall 400. A plurality of display segments 408, 410, and 412 are situated in a rotation configuration. The display segments are adjusted via rollers 404 and 406 based upon a particular game of chance that is selected by the player for display on the display screen 302. For example, the display segment 408 is associated with a first game of chance, the display segment 410 is associated with a second game of chance, and the display segment 412 is associated with a third game of chance. Accordingly, the theme displayed on the wall may be adjusted to match the theme of the game of chance selected for display on the display screen 302.

In an aspect of the disclosure, the seating apparatus 100 is in operable communication with a controller that operates adjustment of the display segments 408, 410, and 412. For example, a processor positioned within the seating apparatus 100 may send a communication to a controller situated at the wall 402 to adjust the display segments 408 to a particular display segment based upon the selected game of chance. Alternatively, the processor positioned within the seating apparatus 100 may send a communication with stating the selected game of chance so that the processor positioned at the wall 402 may determine which wall segment to select.

In another aspect of the disclosure, the wall 402 may adjust display segments 408, 410, and 412 electronically instead of via rollers 404 and 406. As another alternative, the display segments 408, 410, and 412 may be adjusted manually. A variety of configurations may be utilized to adjust the display segments 408, 410, and 412.

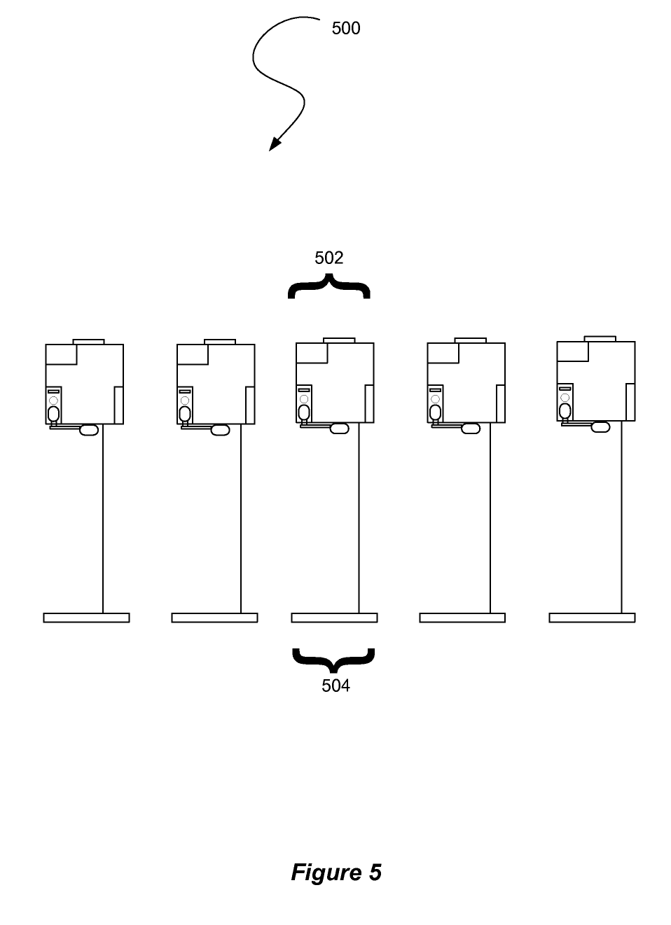

FIG. 5 illustrates a multiple player gaming apparatus configuration 500. The multiple gaming apparatus configuration 500 includes a plurality of game apparatuses 502. Each of the plurality of game apparatuses 502 is similar to the game apparatus 100 described in FIGS. 1A-1D. Further, the multiple gaming apparatus configuration 500 includes a plurality of display screens 504. Each of the plurality of display screens 504 is similar to the display screen 302 described in FIG. 3. Each player can sit at a game apparatus 500. Further, each player may utilize a display screen 302 that corresponds to a particular game apparatus 502 or may utilize multiple display screens 302.

In an aspect of the disclosure, the multiple player gaming apparatus configuration 500 may be utilized to operate a multiple player game of chance. Each player may set at a gaming apparatus in the plurality of gaming apparatuses 502. Each of the display screens 504 displays a portion of the game of chance that is played by the players. For example, each display screen may display a reel of a casino game. Each player participates in the game of chance that is displayed by the plurality of display screens 504.

In another aspect of the disclosure, the multiple player gaming apparatus configuration 500 may be utilized to provide a game of chance in which each display screen is associated with a corresponding seating apparatus from the plurality of seating apparatuses. For example, a seating apparatus 502 corresponds to a display screen 504 in front of which the seating apparatus 502 is situated. The seating apparatus 502 is in operable communication with the display screen 504. Each player may play the multiple player game of chance based upon the particular game of chance data displayed at the corresponding display screen 504. In such configuration, the processor in each seating apparatus 502 may be utilized to determine a portion of the game played by all of the players. For example, each seating apparatus 502 may have a processor that is responsible for randomly determining a reel displayed at a corresponding display screen 504.

In yet another aspect of the disclosure, the multiple player gaming apparatus configuration 500 may be utilized to by multiple players to play independent games of chance. The games of chance may be the same or distinct based upon player selection. Alternatively, independent games may be initially played. An event may then activate a multiple player game, e.g., all the players press a spin button simultaneously, a player receives an outcome that provides a bonus session to another player to player a multiple player game, etc. The plurality of display screens 504 may then change to provide a display of the entire game.

In another aspect of the disclosure, the multiple player gaming apparatus configuration 500 may be utilized by a player to have multiple display screens 504 for the same of game of chance without playing with other players. For example, a player may be the only player that occupies a seating apparatus 502. The player may utilize the display screens 504 for operation of the game of chance. For instance, the player may utilize each of the display screens 504 as a reel in a game of chance.

In one implementation, a player can remove the display screen 198 to interact with the display screen 302. For example, the player may sit at the game apparatus 500 and then decide to stand during game play. The player can carry the display screen 198 and provide inputs to the display screen 302 while standing. A player that is not seated at a game apparatus 500 may be given a display screen 198, e.g., tablet device, to interact with a display screen 198 even though the player is not seated at a game apparatus 500.

The processes described herein may be implemented in a general, multi-purpose or single purpose processor. Such a processor will execute instructions, either at the assembly, compiled or machine-level, to perform the processes. Those instructions can be written following the description of the figures corresponding to the processes and stored or transmitted on a computer readable medium. The instructions may also be created using source code or any other known computer-aided design tool. A computer readable medium may be any medium or storage device capable of carrying those instructions and include a CD-ROM, DVD, magnetic or other optical disc, tape, silicon memory, e.g., removable, non-removable, volatile or non-volatile, packetized or non-packetized data through wireline or wireless transmissions locally or remotely through a network.

A computer is herein intended to include any device that has a general, multi-purpose or single purpose processor as described above. For example, a computer may be a kiosk, a tablet device, a smartphone, a set top box, cell phone, portable media player, etc.

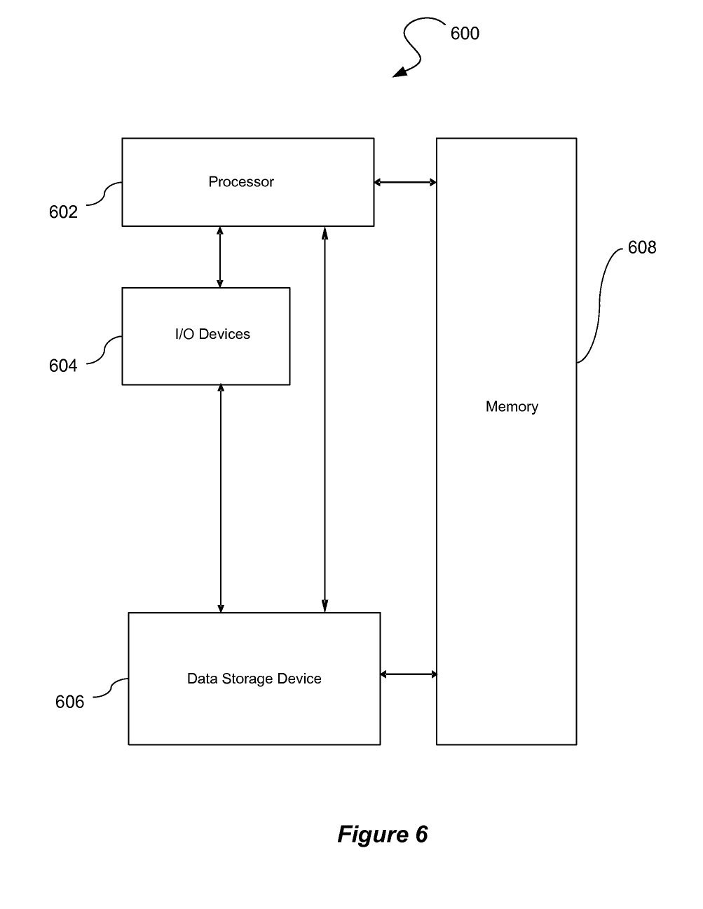

FIG. 6 illustrates a system 600 that may be positioned within the cabinet 152 of the seating apparatus 100 illustrated in FIG. 1B. The system 600 may be utilized to store a variety of games of chance, select a game of chance, accept payment for a game of chance, operate a game of chance, and display a game of chance. The system includes a processor 602, input/output (“I/O”) devices 604, a data storage device 606, and a memory 608. The data storage device 606 may store the plurality of games of chance. The processor 602 may retrieve a particular game of chance from the data storage device 606 based upon a user selection.

The seating apparatus for operation of a game of chance may be utilized for a game of chance that is operated for game play of a game based upon receipt of a wager and determination of a random outcome for a player prize. A game of chance is typically provided on a casino floor. The game of chance may be a casino game, lottery game, bingo game, etc. A game of chance will typically be operated with a random number generator or a manual random determination of an outcome. The game of chance may be a Class II or a Class III game. If the game of chance is a bingo game, the game of chance may or may not be limited to a finite quantity of bingo cards. In an aspect of the disclosure, the seating apparatus communicates with a casino network for operation of the game of chance. In another aspect of the disclosure, the casino game is played upon receipt of a wager corresponding to an outcome of the game of chance.

The seating apparatus 100 for operation of a game of chance as illustrated in FIGS. 1A-1D may be configured as an integrated platform for a customizable gaming device. In contrast with previous configurations in which casino operators were limited to utilizing a few manufacturers to purchase standard slot machines that other casino operators also utilized, the integrated platform allows casino operators to customize their particular brands in unique customized experiences for the customers at the different casinos. As an example, a casino may regularly receive customers of a certain age range and can attempt to get more customers in that age range with particular customizations that may generate interest amongst such customers. The integrated platform allows casino operators to customize the look and feel of the seating apparatus 100 for operation of a game of chance according to brand specific customizations, e.g., a theme of a casino. Further, the integrated platform allows casino operators to customize the seating apparatus 100 for operation of a game of chance to enhance players' experiences in a customized manner.

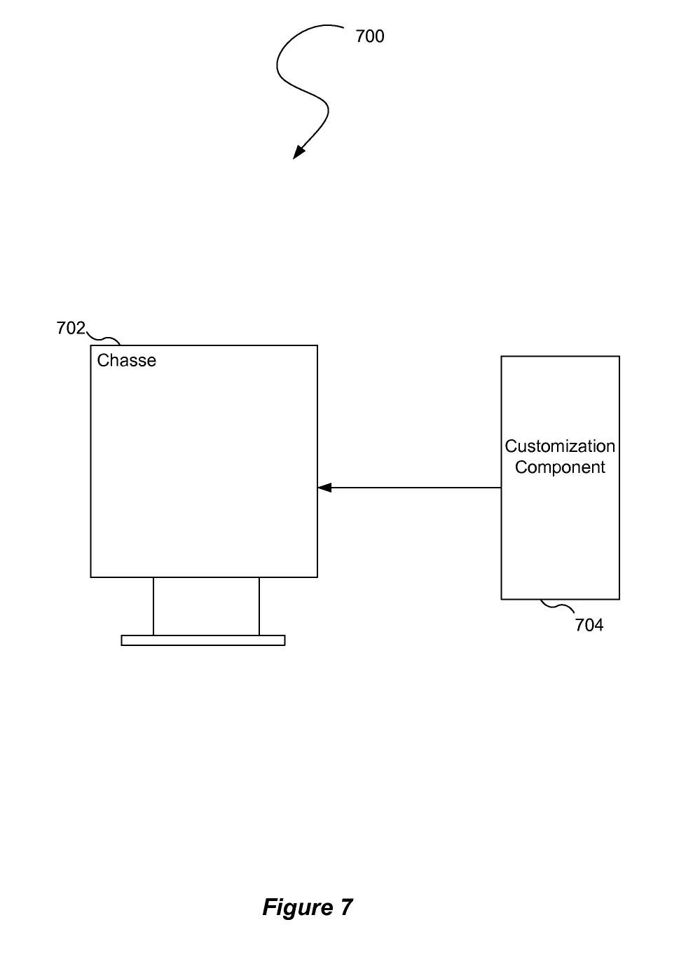

FIG. 7 illustrates an integrated platform 700 that integrates customizations for the seating apparatus 100 for operation of the game of chance. A chasse 702 is a frame that configured to receive various customizations such as a customization component 704. A plurality of customization components 704 may be utilized to provide different customizations.

The chasse 702 may be constructed from wood, metal, or any other material that provides durability for the seating apparatus 100 for operation of the game of chance. Further, the chasse 702 can be configured to comply with regulatory requirements. The chasse 702 may or may not include the operational components for the seating apparatus 100. For instance, the chasse 702 may include the seating receptacle 102, a processor, and a data storage device. The chasse 702 may instead include only some of those components. The remaining components may be customized by the casino operator. For example, a casino operator may want a faster processor than another casino operator. As another example, a casino operator may want a data storage device that has more storage space than another casino operator to store more games. The chasse 702 may also just be a frame without any additional features. The operational components may then be determined as customization components 704.

The customizable component 704 is operably attached to the chasse 702. For instance, the customization component 704 can be a fabric, plastic, electronic component, video component, audio component, etc. The casino operator can select materials such as fabrics and plastics so that the seating apparatus 100 has a particular shape and look and feel. For example, a particular casino operator may select a fabric and material that gives the seating apparatus 100 a cushioned look and feel to match a decor of that casino whereas another casino operator may select a fabric and material that gives the seating apparatus 100 a plastic look and feel to match a different decor for a different casino. The casino operator may also select various colors and other features for those materials.

The electronic component can provide a variety of different features. For example, the electronic component can be an electronic massage motor allows the seating apparatus 100 to provide a message to customers that sit in the seating apparatus 100. The electronic component can also be a seat warmer that warms upon receipt of a user input. The electronic component can also be a reclining device that automatically adjusts various recline configurations based upon receipt of user recline inputs. Instead of an electronic component, a manual recline component can be utilized as the customization component 704. For instance, the customization component 704 can be a lever that a customer adjust to adjust a recline parameter of the seating apparatus 100.

The customization component 704 can also be a parameter rather than a device. For example, the customization component 704 can be a distance between the seating apparatus 100 and the display screen 302 illustrated in FIG. 4. The customization component 704 can also be a device that adjusts the distance between the seating apparatus 100 and the seating apparatus 100. For instance, the customization component 704 may be a track on which the seating apparatus 100 and the display screen 302 sit. The customization component 704 can then receive user inputs to activate movement of the seating apparatus 100 toward the display screen 302 on the track or movement of the display screen 302 toward the seating apparatus 100. Instead of a track, other mechanisms such as robotic arms may be utilized to provide such movement. The customization component 704 can also be a parameter such as a color, casino name, logo, or other feature.

Therefore, a casino operator is able to utilize the integrated platform 700 to customize the seating apparatus 100 in a brand specific manner for a particular casino. The casino operator is also able to utilize the integrated platform 700 to customize the player experience for particular players to enhance their experiences utilizing the seating apparatus 100 for operation of a game of chance. For example, a casino operator can provide certain features that generate interest amongst millenials to play a game of chance at the seating apparatus 100 on a casino floor.

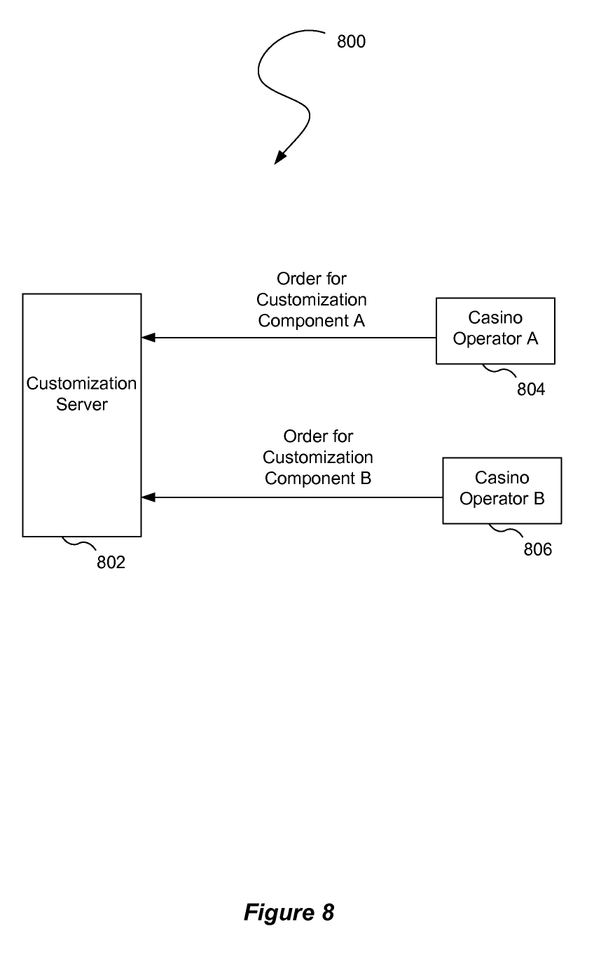

In one embodiment, casino operators or other entities can select and order customization components 704 through an online configuration. FIG. 8 illustrates a customization component online ordering system 800. The customization component online ordering system 800 has a customization server 802 through which various casino operators can place orders for various customization components 704. For instance, a casino operator A 804 can place an order for a customization component A through the customization server 802. A casino operator B 806 can also place an order for a customization component B through the customization server 802. The orders can be just for customization components 704 or for an entire integrated platform 700. For instance, a casino operator may have already ordered a chasse 702 and simply want to order the customization components 704 to attach to that chasse 702. The casino operator may have instead already ordered an integrated platform with a chasse 702 and customization components 704, but may need replacement customization components 704 or simply different customization components 704 to change customizations based upon a different casino theme. The casino operator may also simply order a new integrated platform 700 with a new chasse 702 and new customization components 704.

In one embodiment, an entity associated with the customization server 802 performs the integration of the chasse 702 and the customization components 704. For example, the entity receives an order for an integrated platform 700 with particular customization components 704 from a casino operator. The entity assembles the integrated platform 700 with a chasse 702 and the particular customization components 704 requested by the casino operator. The entity then sends the integrated platform 700 to the casino operator. In another embodiment, the entity does not assemble the integrated platform 700. The entity sends the chasse 702 and the customization components 704 to the casino operator so that the casino operator can assemble the integrated platform 100.

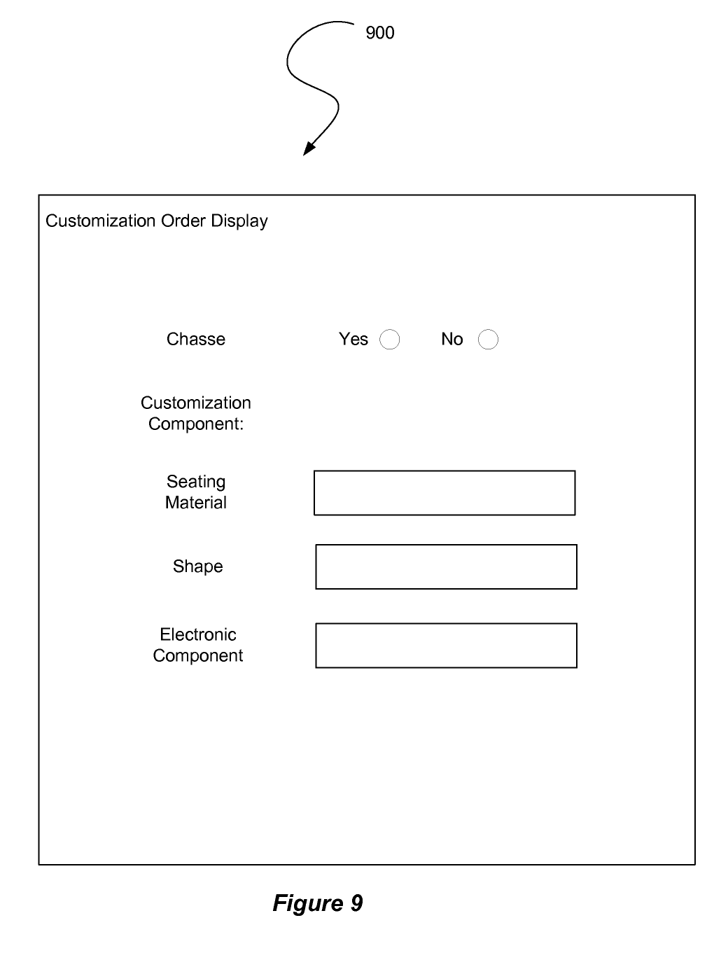

FIG. 9 illustrates an example of a customization order display 900. Various computing devices that interact with the customization server 802 can be utilized by casino operators to display the customization order display 900 to place an order for an integrated platform 700, a chasse 702, or a customization component 704. For example, the casino operator may select whether or not the casino operator wants to order a chasse. Further, the casino operator can provide inputs such as manual inputs, drop down selections, etc. for particular types of customization components such as seating material, shapes, electronic components, etc. The illustrated customization component fields are provided for illustration purposes only. Various other customization component fields may be utilized instead.

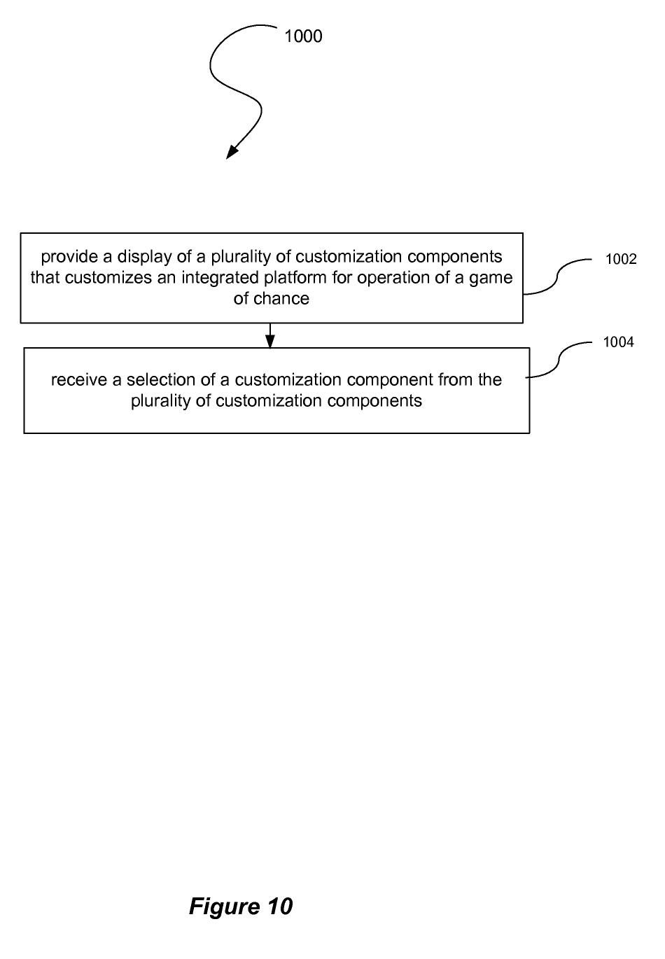

FIG. 10 illustrates a process 1000 that is utilized provide ordering of integrated platform 700. At a process block 1002, the process 1000 provides a display of a plurality of customization components that customizes an integrated platform for operation of a game of chance. Further, at a process block 1004, the process 1000 receives a selection of a customization component from the plurality of customization components.

In another embodiment, the chasse 702 illustrated in FIG. 7 can be utilized for multiple seating arrangements. For example, the chasse 702 can be utilized for a couch that seats multiple customers. The chasse 702 can also be utilized for multiple seats that are connected to each other. The multiple seating arrangements can be attached to or in communication with a single display screen 302 or multiple display screens 302. Further, the multiple seating arrangements can be attached to or in communication with a single input device for game play or multiple input devices for game play. Therefore, the seating apparatus 100 may be utilized by multiple players to play the same or different games of chance. The multiple players may utilize the same or different display monitors and/or input devices.

The process 1000 can be utilized by casino operators to customize the chasse 702 according to the different decor and branding of different casinos. For instance, a casino operator may choose to have a lounge atmosphere that only has multiple seating arrangements to provide a social atmosphere. The casino operator may customize the multiple seating arrangements so that multiple players have to share an input device and/or a display screen to encourage social interaction during game play.

Casino operators can also utilize the process 1000 to customize the display screen 302. For instance, casino operators can customize the display screen 302 to that a portion of the display screen provides a gaming display whereas another portion of the display screen provides a non-gaming display. For example, a customization component 704 can be a camera. The seating apparatus would then allow a user to display game data on a portion of the display screen 302 and display a video application on the other portion of the display screen 302, e.g., through a video messaging application that utilizes the camera. The non-gaming portion of the display screen 302 can also display sports videos, news, shows, etc. Casino operators can utilize the process 1000 to order particular computer hardware components, e.g., display screens 302, graphics processors, modems, etc., that allow for display of non-gaming data in addition to gaming data.

Further, casino operators can utilize the display screen 302 to display multiple games. For instance, the display screen 302 can display multiple tables of a game of chance on the display screen 302. Different portions of the same display screen 302 can be utilized to provide such a display. The player could then play at each displayed table on the same display screen 302. Further, multiple display screen screens 302 can be utilized to display different games of chance. For instance, a community bonus game may be activated for display on multiple display screens 302. The outcome of the community bonus game may or may not be displayed based upon a user input.

It is understood that the apparatuses, processes, and systems described herein may also be applied in other types of apparatuses, processes, and systems. Those skilled in the art will appreciate that the various adaptations and modifications of the embodiments of the apparatuses, processes, and systems described herein may be configured without departing from the scope and spirit of the present apparatuses, processes, and systems. Therefore, it is to be understood that, within the scope of the appended claims, the present apparatuses, processes, and systems may be practiced other than as specifically described herein.

I claim:

1. An integrated platform apparatus comprising:
a chasse; and
a customization component that is operably connected to the chasse that customizes the integrated platform for operation of a game of chance.

2. The apparatus of claim 1, wherein the chasse comprises a seating receptacle.

3. The apparatus of claim 2, further comprising a data storage device positioned within the seating receptacle, the data storage device storing a plurality of games of chance.

4. The apparatus of claim 2, further comprising a data input device positioned within the seating receptacle.

5. The apparatus of claim 4, further comprising a processor positioned within the seating receptacle, the processor selecting a game of chance from the plurality of games of chance based upon an input received from the data input device and operating the game of chance for game play.

6. The apparatus of claim 5, wherein a display device is operably connected to the chasse, the display device receiving game display data from the processor.

7. The apparatus of claim 1, wherein the customization component comprises a seating receptacle.

8. The apparatus of claim 7, further comprising a data storage device positioned within the seating receptacle, the data storage device storing a plurality of games of chance.

9. The apparatus of claim 7, further comprising a data input device positioned within the seating receptacle.

10. The apparatus of claim 9, further comprising a processor positioned within the seating receptacle, the processor selecting a game of chance from the plurality of games of chance based upon an input received from the data input device and operating the game of chance for game play.

11. The apparatus of claim 10, wherein a display device is operably connected to the chasse, the display device receiving game display data from the processor.

12. A method comprising:
providing a display of a plurality of customization components that customizes an integrated platform for operation of a game of chance; and
receiving a selection of a customization component from the plurality of customization components.

13. The method of claim 12, further comprising receiving, at a server, the selection through a network.

14. The method of claim 12, further comprising assembling the integrated platform by connecting the customization component to a chasse.

15. The method of claim 12, wherein the chasse comprises a seating receptacle.

16. The method of claim 15, wherein a data storage device is positioned within the seating receptacle, the data storage device storing a plurality of games of chance.

17. The method of claim 15, wherein a data input device is positioned within the seating receptacle.

18. The method of claim 17, wherein a processor is positioned within the seating receptacle, the processor selecting a game of chance from the plurality of games of chance based upon an input received from the data input device and operating the game of chance for game play.

19. The method of claim 18, wherein a display device is operably connected to the chasse, the display device receiving game display data from the processor.

20. The method of claim 19, wherein the display device is stored in a cabinet that stores high voltage components for operation of the game of chance at the seating apparatus.
